(19) United States
(12) Patent Application Publication
(10) Pub. No.: US 2002/0125436 A1
(43) Pub. Date: Sep. 12, 2002

(54) Detection of ophthalmic mouldings in a package

(76) Inventors: Achim Muller, Grossostheim (DE); Roger Biel, Frankfurt am Main (DE)

Correspondence Address: THOMAS HOXIE, NOVARTIS CORPORATION, PATENT AND TRADEMARK DEPT, 564 MORRIS AVENUE, SUMMIT, NJ, 079011027

(21) Appl. No.: 10/141,746

(22) Filed: May 9, 2002

Related U.S. Application Data
(63) Continuation of application No. 09/784,471, filed on Feb. 15, 2001.
Application No. 09/784,471 is a continuation of application No. 09/566,251, filed on May 5, 2000.

(30) Foreign Application Priority Data
May 4, 1999 (DE) 99108810.5

(51) Int. Cl. G01J 5/02

(52) U.S. Cl. 250/341.2; 250/341.1

(57) ABSTRACT

The invention relates to a method and a device for detecting the presence of an ophthalmic molding consisting of a biocompatible polymeric material, especially an ophthalmic lens, particularly a contact lens, in a package. The invention solves the problem through the use of a spectroscopic process. Packages containing a molding, especially a contact lens, have a characteristic change in their measuring spectrum compared with a package without a contact lens. By evaluating the spectra, it is possible to determine whether or not there is a contact lens in a package. In particular, by using the measuring method according to the invention, one can determine directly after the filling procedure whether there is a contact lens in the package. In addition, the invention is suitable for checking whether contact lenses are contained in the already sealed package. During this procedure, the package remains intact.

The invention relates to a method and a device for registering the presence of an ophthalmic moulding consisting of a biocompatible polymeric material, especially an ophthalmic lens, particularly a contact lens, in a package.

Ophthalmic mouldings are usually put away in a package for storage and for transport. The packages in question are frequently so-called blister packages. A blister package consists of a plastic container, for example of polypropylene (PP), the upper side of which is sealed with film after the moulding has been placed in the plastic container.

Contact lenses that are produced in large unit numbers, for example disposable contact lenses in particular, are sealed in blister packages. Such contact lenses are preferably manufactured by the so-called mould or full-mould process. In this process, the lenses are manufactured into their final shape between two moulds, so that there is no need to subsequently finish the surfaces of the lenses, nor to finish the edges. Moulding processes are described for example in PCT application no. WO/87/04390 or in European patent application EP-A-0 367 513.

To manufacture a contact lens, first of all a certain amount of a flowable starting material is placed in the female mould half. Afterwards, the mould is closed by placing the male mould half thereon. Normally, a surplus of starting material is used, so that, when the mould is closed, the excess amount is expelled into an overflow area outwardly adjacent to the mould cavity. The subsequent polymerisation or crosslinking of the starting material takes place by radiation with UV light, or by heat action, or by another non-thermal method.

The contact lenses produced in this manner are moulded parts having little mechanical stability and a water content of more than 60% by weight. After manufacture, the lens is inspected, then ed and subjected to heat sterilisation at 121° C. in an autoclave.

In U.S. Pat. No. 5,508,317, a new contact lens material is described, which represents an important improvement in the chemistry of polymerisable starting materials for the manufacture of contact lenses. The patent discloses a water-soluble composition of a prepolymer, which is filled into the mould cavity and then crosslinked photochemically. Since the prepolymer has several crosslinkable groups, the crosslinking is distinguished by its high quality, so that a finished lens of optical quality can be produced within a few seconds, without the necessity for subsequent extraction or finishing steps. Owing to the improved chemistry of the starting material as illustrated in the patent, contact lenses can be produced at considerably lower cost, so that in this way it is possible to produce disposable lenses that are used only once.

Optical components produced in series, e.g. contact lenses, have to be checked for defects such as scratches, shrinkage or edges that have broken away. The components recognised as faulty are then rejected. However, at the moment there is no provision for checking whether a package has actually been filled with a contact lens. Under certain circumstances, empty packages may appear, which are not recognised. The client then discovers the empty package and is of course annoyed. However, if empty packages are recognised by chance or by spot checks, then either the whole batch has to be rejected or all the contact lens packages have to undergo 100% manual testing. Both procedures involve substantial costs.

The invention is therefore based on the problem of providing a testing method with which it is possible to inspect, at low cost, whether an ophthalmic moulding is actually present in the package.

The invention solves this problem with the features indicated in claim 1. As far as further essential refinements are concerned, reference is made to the dependent claims.

By using a spectroscopic method, it is possible to determine the presence of ophthalmic mouldings in a package. Packages containing a moulding, especially a contact lens, have a characteristic change in their measuring spectrum compared with a package without a contact lens. By evaluating the spectra, it is possible to determine whether or not there is a contact lens in a package. In particular, by using the measuring method according to the invention, one can determine directly after the filling procedure whether there is a contact lens in the package. In addition, the invention is suitable for checking whether contact lenses are contained in the package which has already been sealed. During this procedure, the package remains intact.

Further details and advantages of the invention may be seen from the description that follows and the drawing. In the drawing,

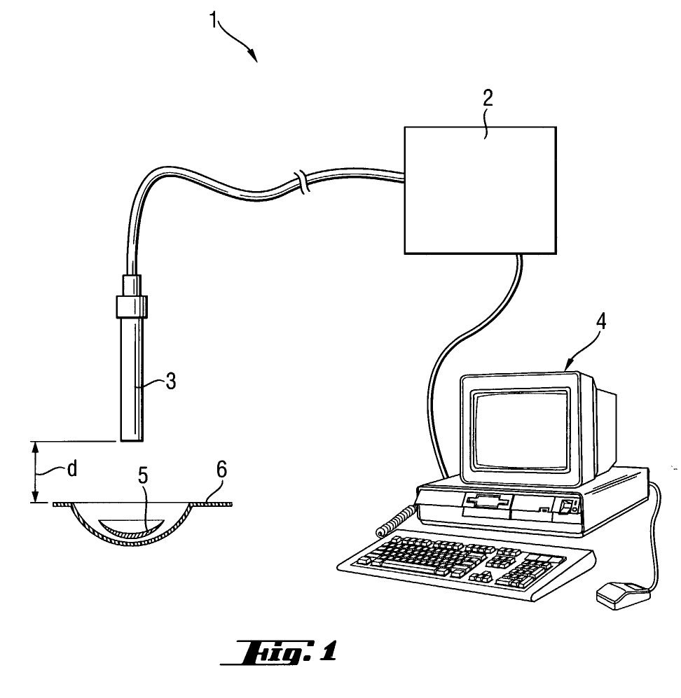

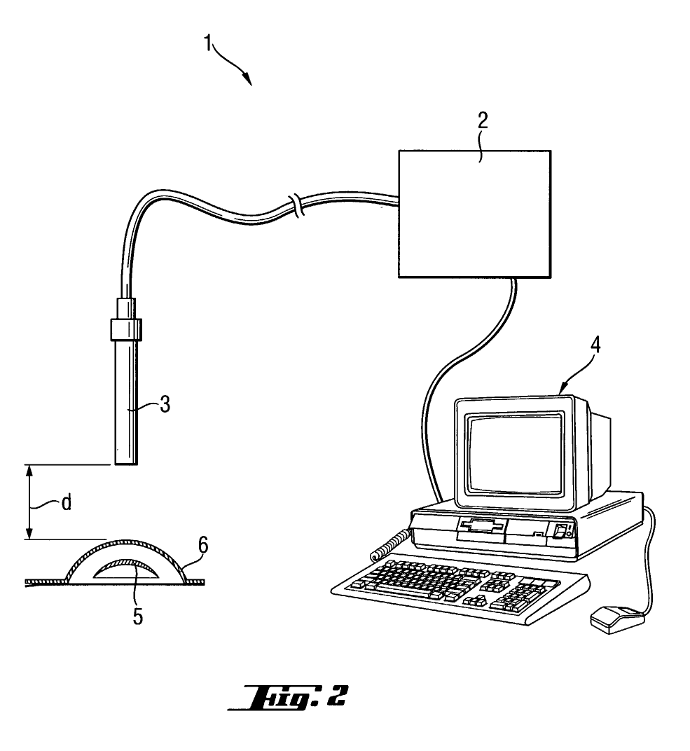

FIG. 1 shows a schematic illustration of an embodiment of a measuring device according to the invention with an open package;

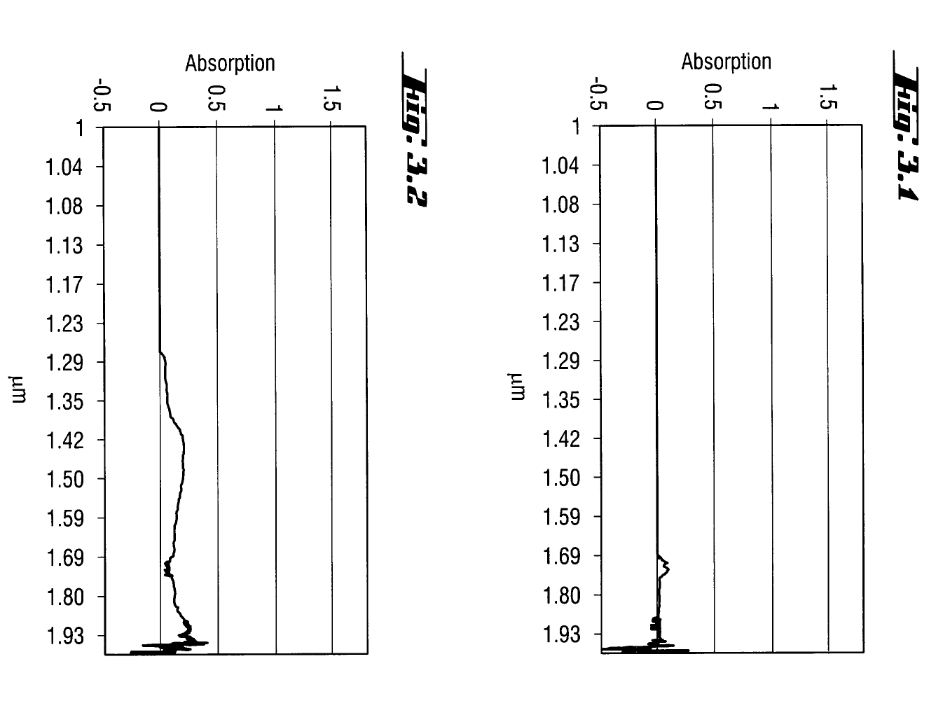

FIG. 2 shows a schematic illustration of an embodiment of a measuring device with a closed package;

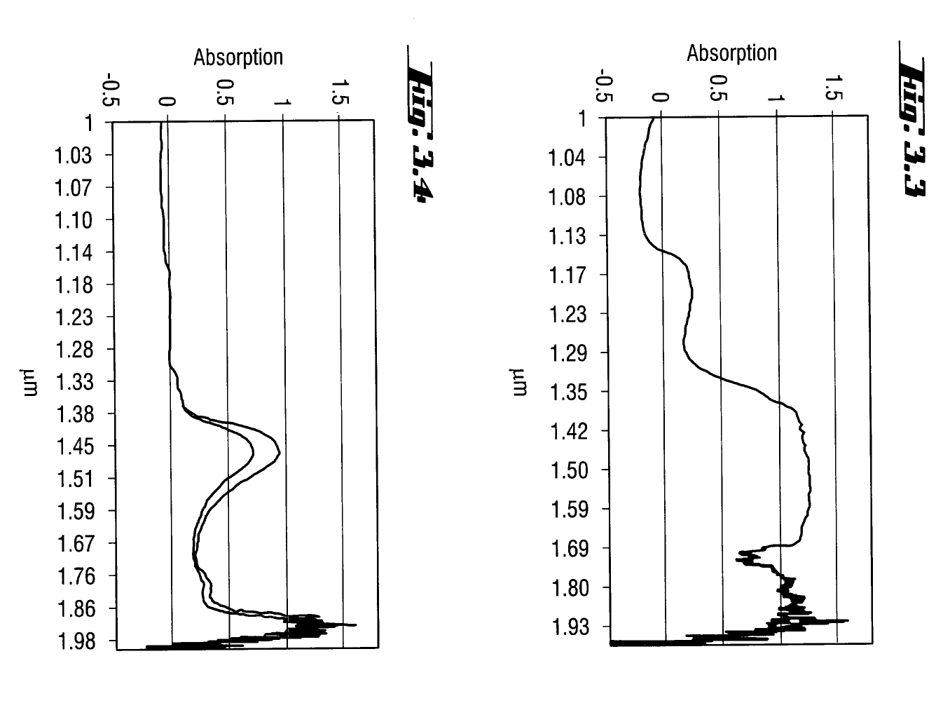

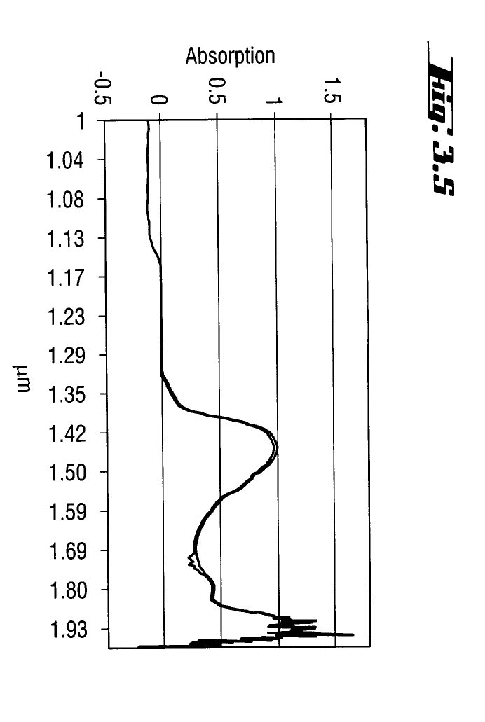

FIG. 3 shows an illustration of different measuring spectra, respectively at a distance of 40 mm for the following test parameters, whereby the absorption is respectively plotted against the wave length of the radiated NIR light:

3.1. PP container without contact lens and dry;

3.2. PP container without contact lens and with water drops of a diameter of ca. 2-4 mm;

3.3. PP container without contact lens and half-full with distilled water;

3.4. PP container with contact lens which has been moistened with water drops of a diameter of ca. 2-4 mm;

3.5. PP container with contact lens that has been dabbed.

In FIG. 1, a measuring device 1 is illustrated. The measuring device comprises a spectrometer 2, which is linked to a fibre optic 3 and is attached to a computer 4 to evaluate the data. In the embodiment illustrated, measurements are carried out in near infrared (NIR). An appliance from the company Bruker of the type IFS 28/N is used as the NIR spectrometer. However, in the context of the invention, it is possible to carry out measurements in the whole infrared range, and also in the whole electromagnetic wave range, including UV and microwaves. The fibre optic 3 is advantageously set up for measurements in reflection, i.e. one part of the fibres serves to irradiate the sample with NIR light, while another part receives the reflected radiation and passes it to the spectrometer 2. An ophthalmic moulding, preferably a contact lens 5, is located in a container 6 and is exposed to rays from the NIR light emerging from the fibre optic 3. The reflected light is similarly received by the fibre optic 3 and passed on to the NIR spectrometer 2 for detection. The container 6 preferably consists of polypropylene (PP). The distance d between the container 6 and the fibre optic 3 can be varied.

The measuring process according to the invention is not an imaging process, since no image is made of the moulding 5 to be examined. Instead, resonance vibrations are detected from certain atom groups of the biocompatible polymeric material from which the moulding is made, which have been stimulated by the radiated NIR light. Furthermore, it is also possible to provide the moulding with moistening means which are stimulated by the radiated NIR light. In addition, it is also conceivable in terms of the invention for the ophthalmic moulding to carry out a chemical reaction with a further substance that is filled into the package, this reaction is used for the detection of resonance vibrations. In this case, the resonance vibrations only occur if an ophthalmic moulding, such as a contact lens, is located in the package.

The following tests were carried out by way of example with contact lenses 5 made of PVA. PVA is a prepolymer containing several crosslinkable groups, as well as C—OH groups. In the tests carried out, the distance between the contact lens 5 and the fibre optic 3 was varied, measurements being made preferably at 10, 20, 30 and 40 mm. At each distance, a background measurement was made (basic measurement) with an empty, dry PP container. This background measurement is read automatically by the spectrometer from the spectra subsequently received.

In the measuring arrangement according to FIG. 1, i.e. in a test from above into the open PP container, the following measurements were carried out.

1. PP container without contact lens and dry;

2. PP container without contact lens and with water drops of a diameter of ca. 2-4 mm;

3. PP container without contact lens and half-full with distilled water;

4. PP container with contact lens which has been moistened with water drops of a diameter of ca. 2-4 mm;

5. PP container with contact lens that has been dabbed.

Each measurement was repeated three times, the sample being repositioned below the fibre optic each time.

It was demonstrated that the spectra of the PP containeres with no contact lenses differed considerably in form from those with contact lenses. This clearly depends on the distance from the measuring optics to the sample. It was shown that a distance of 40 mm between the package 6 and the fibre optic 3 in the apparatus used was advantageous, since at this distance the whole area in which the contact lens could be found was detected.

The received spectra for a distance of 40 mm are illustrated in FIG. 3. In the spectra illustrated in FIGS. 3.1-3.5, the absorption was plotted against the wavelength of the radiated NIR light. For a PP container without contact lens (FIG. 3.1), the measurements show no absorption of the radiated light. If there are water drops in the PP container (FIG. 3.2), slight absorption is detected. As the container is increasingly filled with water, the absorption increases, whereby it extends over a broad wavelength area and no specific structure is recognised (FIG. 3.3). In contrast, if a contact lens 5 is in the container 6 with or without water drops, a significant peak is established with its maximum at a wavelength of 1.45 μm (FIGS. 3.4, 3.5). This peak only occurs if a contact lens is present in the package, and it is therefore a suitable characteristic of a filled package. Of course, it is also possible in the context of the invention to select a resonance frequency at another wavelength, which is equally characteristic for the ophthalmic moulding.

Measurements undertaken on a sealed PP container show that in principle it is possible to detect contact lenses through the PP container. The measurement signal is smaller than in tests on the open container, but still clearly distinguishable.

In all, the invention offers the possibility of checking the presence of mouldings, especially ophthalmic lenses, particularly contact lenses, in a package which can be either open or closed. In particular, the NIR spectroscopy illustrates a very interesting method of detecting contact lenses in the package.

What we claim is:

1. Method of detecting the presence of ophthalmic mouldings, especially ophthalmic lenses, particularly contact lenses, consisting of a biocompatible polymeric material, the moulding being located in an open or closed package, characterized in that the moulding is exposed to electromagnetic radiation and the measuring spectrum is detected, whereby a resonance frequency is selected which is characteristic for the moulding and/or for a substance linked with the moulding.

2. Method according to claim 1, in which electromagnetic radiation in the infrared range is selected.

3. Method according to claim 1 or 2, in which radiation in the near infrared range is selected.

4. Method according to one or more of claims 1 to 3, in which a fibre optic is used to irradiate the package.

5. Method according to one or more of claims 1 to 4, in which the distance from the irradiation optics to the package is between 5 mm and 100 mm.

6. Method according to one or more of claims 1 to 4, in which the distance from the irradiation optics to the package is between 30 mm and 50 mm.

7. Method according to claim 5 or 6, in which the distance from the irradiation optics to the package is about 40 mm.

8. Method according to one or more of claims 1 to 7, in which the package consists of polypropylene.

9. Method according to one or more of claims 1 to 9, in which the ophthalmic moulding is a contact lens.
